(19) United States
(12) Patent Application Publication
(10) Pub. No.: US 2018/0074314 A1
(43) Pub. Date: Mar. 15, 2018

(54) DISPLAY MEMBER AND HEAD-UP DISPLAY APPARATUS

(71) Applicant: Konica Minolta, Inc., Tokyo (JP)

(72) Inventors: Hironori Takahashi, Tokyo (JP); Tomokazu Taguchi, Tokyo (JP); Yasushi Mizumachi, Tokyo (JP)

(73) Assignee: Konica Minolta, Inc., Tokyo (JP)

(21) Appl. No.: 15/558,786

(22) PCT Filed: Mar. 22, 2016
(86) PCT No.: PCT/JP2016/058914

§ 371 Date: Sep. 15, 2017

(30) Foreign Application Priority Data
Mar. 27, 2015 (JP) 2015-065605

(51) Int. Cl. G02B 27/01; B60K 35/00; B60K 37/02; G02B 1/14; G02B 1/04

(52) U.S. Cl. CPC G02B 27/0101; B60K 35/00; B60K 37/02; G02B 2027/0194; G02B 1/04; B60K 2350/1072; B60K 2350/2052; G02B 1/14

(57) ABSTRACT

A display member includes a base made of resin, and a hard coat layer disposed on the base. A plurality of conical protrusions protrude from the surface of the base and are covered with the hard coat layer. Each of a height d of the conical protrusion from the surface of the base and a radius r of a cross section of a bottom surface obtained by cutting the conical protrusion along the surface of the base at a position nearest to the base is a dimension of 700 nm or less, and the total area of the bottom surface of the conical protrusions is 70% to 92% with respect to a unit area of the base.

### TECHNICAL FIELD

The present invention relates to a head-up display apparatus which makes, for example, the use in a car a main application. In more detail, the present invention relates to a head-up display apparatus which can visualize both a vehicle front scenery visualized by light passing through a combiner via a translucent display member (combiner) and images or information provided by light reflected on the combiner by superimposing the vehicle front scenery and the images or information on the field of view of a driver, and to a display member used for the head-up display apparatus.

### BACKGROUND

The head-up display apparatuses are known as a means which projects information directly on the field of view of a driver. For example, during driving a car, the head-up display apparatus projects information such as speeds on meters directly as a virtual image in front of a driver in the car. Accordingly, the head-up display apparatus allows the driver to drive without changing a line of sight and focus, thereby having a function which leads to accident prevention.

In recent years, it has been expected too much that the spread of the head-up display apparatus capable of reducing the load of a driver will be further promoted.

In one type of the head-up display apparatus, a dedicated combiner is installed on a dashboard of a car. As compared with a type which projects directly onto a windshield, the head-up display apparatus of the above type has high versatility in the point that the design of an optical system is not limited to a specific car type. Accordingly, it is expected that the number of cases adopting the head-up display apparatus increases relatively as the car types installing it are expanding.

Moreover, such a head-up display apparatus is not limited to the use for general cars, and can be used for special work vehicles, airplanes etc., as additional applications following the cars, so as to support operators with the same apparatus constitution. Accordingly, it can be said that the additional applications occupies main positions to support the large prompt spread of head-up-display technology.

Here, in the case where a transparent plastic plate is used as a base which forms the base plate of a combiner, as compared with a case where a glass plate is used, the transparent plastic plate is excellent in manufacturing cost, shock resistance, and the like. On the other hand, the transparent plastic plate has also demerit that surface hardness is low. In order to compensate the demerit of such a plastic plate, for example, to secure surface hardness, techniques, such as coating a hard coat film onto a plastic plate, have been already developed.

However, on the surface of a combiner on which a hard coat film is coated with a micron order thickness, interference light is formed by the interface reflection between atmospheric air and a hard coat film and the interface reflection between the hard coat film and a base arises, and a slight difference in the thickness of the hard coat film influences greatly the spectrum of the interference light. Accordingly, interference fringes (called rainbow unevenness) colored like rainbow are observed specifically on the portions such as end portions of the combiner where it is difficult to control the thickness. These interference fringes not only spoil the quality of outer appearance of a combiner, but also cause fear that image quality of an image to be visualized is lowered.

Moreover, hard coat materials are provided in a form of an optically extremely thick film such as an absolute thickness of a micron order. Accordingly, at this time, in many cases, reflectance spectrum is observed in a form of waving periodically with intervals of a wavelength of several tens nanometers. For this reason, the coating of a hard coat film may be evaded in the applications in which optical characteristics are severely determined.

Techniques have been proposed in Patent Literatures (PTLs) 1-4 below that ease such rainbow unevenness by using a means to reduce an actual difference in refractive index between both materials on the interface between a hard coat film and a base.

### PATENT LITERATURE

PTL 1: Japanese Unexamined Patent Publication No. H08-94801

PTL 2: Japanese Unexamined Patent Publication No. 2003-205563

PTL 3: Japanese Unexamined Patent Publication No. 2000-111706

PTL 4: Japanese Unexamined Patent Publication No. H08-197670

### SUMMARY

However, with the technique of PTL 1, advanced vapor-deposition equipment is needed for forming a hard coat layer, and it is difficult to obtain surface hardness and environmental reliability required for a combiner with the technique of gas phase film formation. Furthermore, with the technique of PTL 2, the thickness of the formed mixed layer is insufficient, and the hardness is also insufficient. In addition, the surface of the base becomes the state of being roughened at random substantially, so that haze (dull deposits) occurs.

Furthermore, with the technique of PTL 3, it is difficult to change a refractive index difference of an interface smoothly and a combination capable of actually using both a base and a hard coat material is limited so that it is difficult to use them. Moreover, with the technique of PTL 4, it is difficult to control the configuration of given rough surface and minute dimensions, so that haze (clouding) occurs.

One or more embodiments of the present invention provide a display member and a head-up display apparatus that have both excellent durability and visibility and can be provided at low cost.

In one or more embodiments, a display member includes a projection plane for use in a head-up display apparatus, wherein when display light is emitted to the projection plane, the display light is reflected on the projection plane, thereby enabling an image shown by the display light to be observed as a virtual image, and enabling a real image having passed through the display member to be observed,

the display member includes a base made of resin, and a hard coat layer disposed on the base,

wherein a plurality of conical protrusions are formed on the surface of the base so as to be covered with the hard coat layer, wherein each of a height d of the conical protrusion from the surface of the base and a radius r in a cross section (hereinafter, called a bottom surface) obtained by cutting the conical protrusion along the surface of the base at a position nearest to the base becomes a dimension of 700 nm or less, and wherein the total area of the bottom surfaces of the conical protrusions is 70% to 92% with respect to a unit area of the base.

Before describing one or more embodiments of the present invention, a description is given to general disadvantages that arise at the time of forming a hard coat layer on a base. FIG. 1 is a schematic diagram showing a cross section of a display member in which a hard coat layer HC is formed on a base ST. For example, in the case where the hard coat layer HC is formed on the base ST by a wet coating method or the like which are comparatively simple construction methods, the thickness of the hard coat layer HC tends to become uneven. In the case where light fluxes L enter in parallel a point P1 and a point P2 as shown in FIG. 1, a phenomenon occurs according to the film thicknesses such that the optical path length of an outgoing light flux L1 which enters the hard coat layer HC from the point P1, is reflected on an interface of the base ST, and exits from a point P3, is different from the optical path length of an outgoing light flux L2 which enters the hard coat layer HC from the point P2, is reflected on an interface of the base ST, and exits from a point P3. In this case, the color components of an interference light flux I1 caused by a reflected light flux of a light flux L reflected on the point P3 and the outgoing light flux L1 are different from the color components of an interference light flux I2 caused by a reflected light flux of a light flux L reflected on the point P4 and the outgoing light flux L2, and rainbow unevenness occurs due to this difference. In contrast, in the case of using techniques of gas phase film formation, such as CVD, the thickness of a hard coat layer can be made uniform in sub-micron order. However, it is difficult to obtain scratch resistance by the gas phase film formation represented by CVD, and further, cracks and film peeling on a hard coat layer are likely to occur. Moreover, Vacuum film formation process is expensive in terms of both introduction cost and running cost of facilities, and product manufacturing cost will become high.

On the other hand, FIG. 2 shows the reflectance characteristics of each of the interference light fluxes I1 and I2 shown in FIG. 1 by plotting reflectance on the vertical axis and wavelength on the horizontal axis. As shown in FIG. 2, each of the reflectance characteristics of the interference light flux I1 indicated with a dotted line and the reflectance characteristics of the interference light flux I2 indicated with a solid line has a characteristic periodically increasing and decreasing according to a wavelength variation, and the respective peak wavelengths of the reflectance characteristics of the interference light fluxes I1 and I2 shift from each other. Originally, the respective reflectance characteristics of the interference light fluxes I1 and I2 coincide with each other and are constant according to wavelengths.

The present inventors found out as a result of dedicated research that the disadvantages identified in FIGS. 1 and 2 can be mitigated by forming a plurality of conical protrusions with a prescribed dimension on the interface between the hard coat layer HC and the base ST. In more concrete terms, in the case where each of the height d of the conical protrusion and the radius r of the bottom surface of the conical protrusion is less than the wavelength of visual light (called sub-wavelength), the conical protrusion has an antireflection effect. Accordingly, visible light having entered the hard coat layer HC proceeds in the base ST without being reflected on the conical protrusions formed on the base ST, and light exiting from the surface of the hard coat layer HC becomes only reflected light. As a result, interference light is not caused. It should be noted that visible light means light with wavelengths of 400 nm to 700 nm.

On the other hand, in the case where each of the height d of a conical protrusion and the radius r of the bottom surface of the conical protrusion is a slightly small dimension with respect to the scale of the wavelength band of visible light, that is, specifically in the case where each of the height d and the radius r is 200 nm or more and 700 nm or less, a refractive index change can be adjusted with the conical protrusions, whereby rainbow unevenness and the like can be suppressed. This effect is described with reference to diagrams. First, FIG. 3(a) is a graph showing the reflectance characteristics obtained by the present inventors through simulations in the case where the refractive index of a base is set to 1.6 and the refractive index of a hard coat layer is set to 1.55. According to FIG. 3 (a), the reflectance is increasing and decreasing at most between 3.9% and 5.5%.

In contrast, FIG. 3(b) is a graph showing the reflectance characteristics obtained through simulations in the case where three intermediate layers with the refractive indexes of 1.59, 1.563, and 1.561 are disposed between the same base and hard coat layer. In this example, the refractive index is changing step-wise, the reflective index is increasing and decreasing at most between 4.2% and 5.3%, and the fluctuation width decreases clearly. However, the forming of many intermediate layers between the base and the hard coat layer leads to an increase in cost.

On the other hand, FIG. 3(c) is a graph showing the reflectance characteristics obtained through simulations in the case where, for example, ideal cones are disposed between the same base and hard coat layer so as to make the refractive index change continuously. In this example, the reflective index is increasing and decreasing at most between 4.6% and 4.75%, and even if comparing with the characteristics shown in FIG. 3(b), the fluctuation width decreases considerably. The ideal cone described here refers to a cone in which, among line segments included in a side face of the cone, a line segment connecting a vertex of the cone and an arbitrary point included in the circumference of the bottom surface becomes a straight line. At this time, a projection image obtained by projecting the ideal cone in parallel to the bottom surface becomes an isosceles triangle correctly.

According to the above simulations, it turns out that the reflectance characteristics can be improved by continuously changing the refractive index between a base and a hard coat layer. Then, in one or more embodiments of the present invention, a plurality of conical protrusions is disposed so as to adjust a refractive index. However, in the case where the dimensions of conical protrusions becomes too large, the conical protrusions cause light scattering and stray light. Accordingly, in one or more embodiments of the present invention, each of the height d and the radius r of the bottom surface of the conical protrusion is made 700 nm or less. Each of the plurality of conical protrusions is an ideal cone.

In this way, in the interface formed by the above-mentioned conical protrusions with the calculated dimensions (d, r), an effective refractive index to its depth direction continuously changes extremely generously. Accordingly, reflection on the interface can be deemed zero. With this, it becomes possible to suppress interference from occurring on light outgoing from the surface of the hard coat layer, namely, it becomes possible to suppress rainbow unevenness. In addition, the above-mentioned conical protrusions are unified with almost equal dimensions of 700 nm or less. Accordingly, different from rough surfaces of the conventional technology, in the case where the display member is used for a head mounted display apparatus for being mounted on a car, the display member will not cause haze etc. considered to cause visibility lowering. Furthermore, the hard coat layer is formed so as to cover the conical protrusions so that the adhesion between the hard coat layer and the conical protrusions becomes good. Accordingly, even if the display member is exposed to comparatively high environmental temperature belts, such as the inside of the car in midsummer, it becomes possible to suppress the hard coat layer from being peeled off, whereby it becomes possible to obtain high durability and reliability. In the case where the total area (hereinafter, called density or compactness factor) of the bottom surfaces of the conical protrusions is made 70% to 92%, or 75% to 92% with respect to a unit area of the base, such effects can be sufficiently secured. In the case where the total area of the bottom surfaces is 92%, the remaining 8% corresponds to the surface of the base, and based on this serving as standard, the height d etc. can be determined. Similarly, in the case where the total area of the bottom surfaces is 75%, the remaining 25% corresponds to the surface of the base. The height d of the conical protrusions is made 150 nm to 300 nm, and the radius r of the bottom surface of the conical protrusions is made 100 nm to 400 nm.

Here, the term “conical” includes an ideal cone and a truncated cone, in addition, further includes a shape in which at least a partial shape of an ideal cone or a truncated cone is slightly modified (partially-reduced dimension or partially-increased dimension). As the configuration of a conical protrusion, a cross section parallel to a bottom surface decreases uniformly and continuously as the position of the cross section moves from the bottom surface to the tip. Furthermore, the shape of the bottom surface may be an elliptical shape etc., and in this case, the half of the maximum diameter of the bottom surface is used as a radius. Moreover, in the case where the bottom surface of a conical protrusion is not a complete circle, the bottom surface is approximated to a circle by a least square method and the like, and then, the radius r is obtained.

In the display member, with respect to the radius r1 of a cross section obtained by cutting the conical protrusion in parallel to the bottom surface at a position of an arbitrary height of the conical protrusion, the radius r2 of a cross section obtained by cutting the conical protrusion in parallel to the bottom surface at a position moved up by 0.1d from the position of the arbitrary height is 0.7r1 to 0.9r1.

As the position of a cross section is moving up by every heights of 0.1d from the bottom surface to the tip of the conical protrusion, in the case where the area of the cross section decreases so as to satisfy r2=0.7r1 to 0.9r1, effect to reduce reflection on the interface between the base and the conical protrusion is extremely high. In one or more embodiments, such a reduction rate is uniform. If r2=0.7r1 to 0.9r1 is satisfied, any route from the bottom surface to the tip may be taken.

Furthermore, in the case where the centers O of the bottom surfaces of three conical protrusions adjoining each other are connected with straight lines, the straight lines form an equilateral triangle.

In the case where the conical protrusions are arranged in the above way, the bottom surfaces are packed closest on the surface of the base on which the bottom surfaces exist, whereby the effect to reduce reflection on the interface becomes extremely high. The equilateral triangle described here is a pure equilateral triangle. However, if, in a triangle, the length of each of three sides falls within ±10% of an average value of the three sides, such a triangle is made to be treated as an equilateral triangle.

In one or more embodiments, a display member includes a projection plane for use in a head-up display apparatus, wherein when display light is emitted to the projection plane, the display light is reflected on the projection plane, thereby enabling an image shown by the display light to be observed as a virtual image, and enabling a real image having passed through the display member to be observed,

the display member includes a base made of resin, and a hard coat layer disposed on the base,

wherein a periodic configuration is formed on the surface of the base so as to be covered with the hard coat layer, wherein the periodic configuration is a configuration in which a plurality of grooves each including a vertical surface existing so as to extend from the base and a slope surface inclining with respect to the vertical surface, are formed along the surface of base so as to extend in parallel to each other, and wherein each of the height of the vertical surface from the base and the width w of the slope surface becomes a dimension of 700 nm or less.

As mentioned above, on the interface formed by the periodic configuration with the calculated dimensions (h, w), an effective refractive index to its depth direction continuously changes extremely generously. Accordingly, with regard to vertical components to the groove among the electromagnetic wave components of incidence light, reflection on the interface can be deemed zero. With this, it becomes possible to suppress interference effectively from occurring on light outgoing from the surface of the hard coat layer, namely, it becomes possible to suppress rainbow unevenness. In addition, the dimensions of the cross section of the above-mentioned grooves are 700 nm or less and unified with almost equal dimensions. Accordingly, different from rough surfaces of the conventional technology, in the case where the display member is used for a head mounted display apparatus for being mounted on a car, the display member will not cause haze etc. considered to cause visibility lowering. Furthermore, the hard coat layer is formed so as to cover the periodic configuration so that the adhesion between the hard coat layer and the periodic configuration becomes good. Accordingly, even if the display member is exposed to a comparatively high environmental temperature range, such as the inside of the car in midsummer, it becomes possible to suppress the hard coat layer from being peeled off, whereby it becomes possible to obtain high durability and reliability.

In the display member of one or more embodiments described above, the above-mentioned hard coat layer is formed by wet coating methods.

In the case where the above-mentioned hard coat layer is formed by wet coating methods, it may be difficult generally to secure a uniform layer thickness. Accordingly, one or more embodiments of the present invention is especially effective. Examples of the wet coating methods may include an immersing method, a spraying method, a spinning method, and the like.

Moreover, the resin used for the above-mentioned base is a polycarbonate type, a PMMA type, a COC type, and a COP type.

The PMMA type resins are excellent in hardness and transparency as a base. Moreover, the COC type resins and COP type resins have very small birefringence, and similarly, they are excellent in optical properties. Especially, the polycarbonate type resins, in addition to the outstanding optical properties, have high shock resistance and are expected in terms of scattering preventing effect in application for cars. Accordingly, the polycarbonate type resins are most preferable in the viewpoint of safety.

Moreover, the materials to form the hard coat layer are transparent resin curable materials of an acrylic type or a silicone type.

In the case where the materials to form the hard coat layer are these transparent resin curable materials, the transparent resin curable materials are used for the materials' coating finish properties and optical properties. In particular, in the case of UV curing type acrylic type polymers, UV curing type acrylic type polymers are excellent in liquid leveling characteristics so that the surface excellent in outer appearance quality after coating can be formed.

Furthermore, the thickness t of the hard coat layer is 1 to 10 μm.

In the case where the thickness t of the hard coat layer is 1 μm or more, excellent surface hardness can be obtained. On the other hand, in the case where that the thickness t of the hard coat layer is 10 μm or less, it is possible to suppress cracks and peeling off. Furthermore, the thickness t of the hard coat layer is 2 to 5 μm. Herein, in the case where the conical protrusions are formed on the surface of the base, the thickness t of the hard coat layer is a distance from the tip of the conical protrusion to the surface of the hard coat layer on the side opposite to the base, and in the case where the periodic configuration is formed on the base, the thickness t of the hard coat layer is a distance from the tip of the vertical surface to the surface of the hard coat layer on the side opposite to the base.

Moreover, this head-up display apparatus includes the above-mentioned display member and a drawing unit which emits display light to the display member.

In one or more embodiments, the head-up display apparatus is mounted on a car and disposed on a position′ where a driver can observe.

Moreover, in one or more embodiments, the head-up display apparatus is disposed on a dashboard of a car.

According to one or more embodiments of the present invention, it is possible to provide a display member and a head-up display apparatus which can suppress rainbow unevenness and has excellent outer appearance quality and visibility. Furthermore, even if being mounted on cars and exposed to severe environment for a long period of time, the display member has reliability being not likely to cause minute cracks and peeling off of coat. When light from a light source such as a head light of an oncoming car at night enters, the display member does not cause flare caused by haze. Moreover, the display member can achieve high transparency, with less haze, capable of displaying a sharp image at low cost.

### BRIEF DESCRIPTION OF DRAWINGS

FIG. 1 is a schematic illustration showing a cross section of a display member in which a hard coat layer HC is formed on a base ST.

FIG. 2 is a diagram showing reflectance characteristics of each of interference light fluxes I1 and I2 shown FIG. 1 by plotting reflectance on the vertical axis and wavelength on the horizontal axis.

FIG. 3 is a graph which shows reflectance characteristics obtained through simulation.

FIG. 4 is an illustration showing a state where a head-up display apparatus according to one or more embodiments is mounted on a car body VH.

FIG. 5 is an illustration showing a constitution of an image drawing unit 100.

FIG. 6 is an illustration schematically showing a cross section of a combiner 200 according to one or more embodiments.

FIG. 7 is a diagram showing a portion indicated with an arrow VII in FIG. 6 by enlarging the portion.

FIG. 8 is a perspective view showing the surface of a base by enlarging the surface.

FIG. 9 is an illustration in which the surface of the base 201 according to one or more embodiments is looked down from the upper portion of conical protrusions.

FIG. 10 is a cross sectional view, similar to FIG. 7, of a combiner according one or more embodiments.

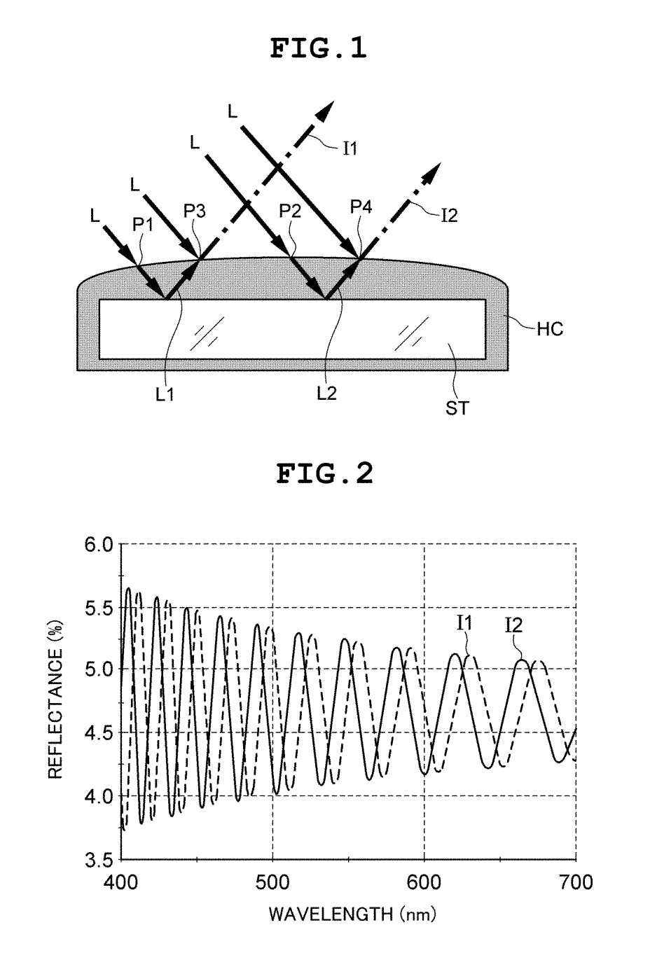

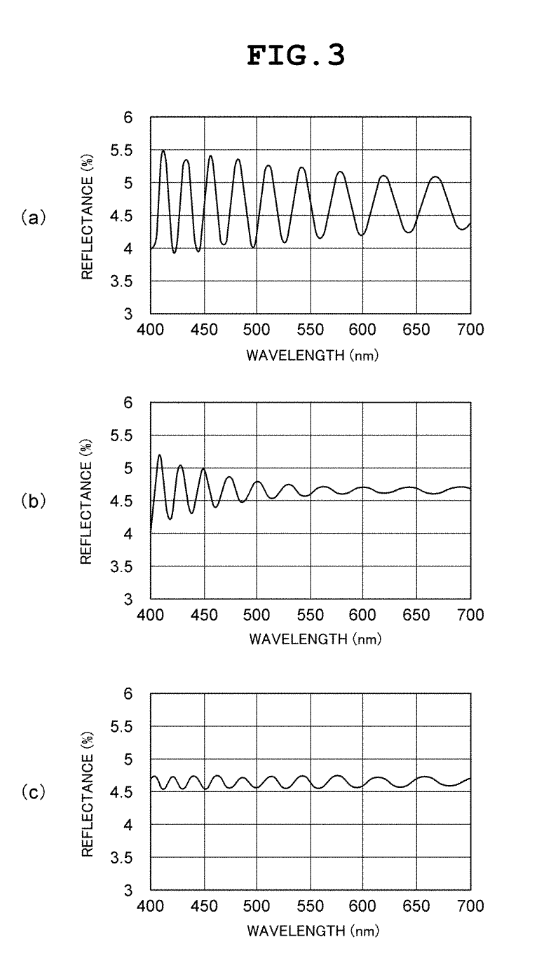

### DETAILED DESCRIPTION

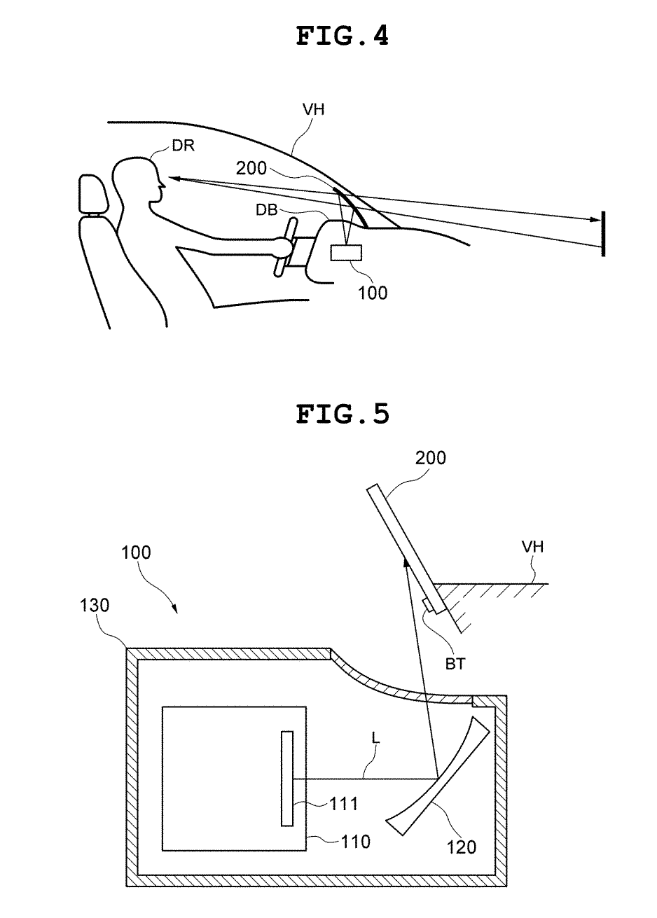

Hereinafter, embodiments of the present invention are described based on the drawings. FIG. 4 is an illustration showing a state where a head-up display apparatus according to one or more embodiments is mounted on a car body VH. An image drawing unit 100 is disposed in a dashboard DB of the car body VH, and is configured to project display light onto a combiner 200 serving as a display member fixedly disposed on the dashboard DB. Such display light is led to the pupil of a driver DR, and is configured to display a virtual image (display image). On the other hand, the driver DR can observe a real image such as scenery having transmitted the combiner in by overlapping the real image on the virtual image. The combiner 200 may be a folding type and may be able to be stored in the dashboard. The image drawing unit 100 and the combiner 200 constitute a head-up display apparatus.

FIG. 5 is an illustration showing a schematic constitution of the image drawing unit 100. The image drawing unit 100 is mainly constituted by an image drawing device 110 equipped with a liquid crystal display panel 111, a concave mirror 120, and a housing 130. The constitution of the image drawing device is described in detail in, for example, Japanese Unexamined Patent Publication No. 2012-203176.

The liquid crystal display panel 111 includes a liquid crystal cell in which a liquid crystal layer is enclosed in a pair of light transmissive base plates on which transparent electrode films are formed, and polarizing plates pasted separately on both front and back surface of the liquid crystal cell. Light rays are led from an unillustrated light source in the image drawing device 110 to the surface of the liquid crystal display panel 111, passes through the liquid crystal display panel 111, becomes display light L, is irradiated to a concave mirror (or flat mirror) 120 constituting a projection optical system, is reflected on the concave mirror, and then, is made to proceed to the combiner 200. The combiner 200 is shaped in the form of a plate with a thickness of 2 to 3 mm (alternatively, 10 mm or less). In the combiner 200, a projection plane (on the driver side) is a concave toric surface (may be a free-form surface or a spherical surface) with a radius of curvature of 100 mm or more in order to form a virtual image, and a back plane (on the vehicle front side) is a spherical surface or an aspherical surface similar to it.

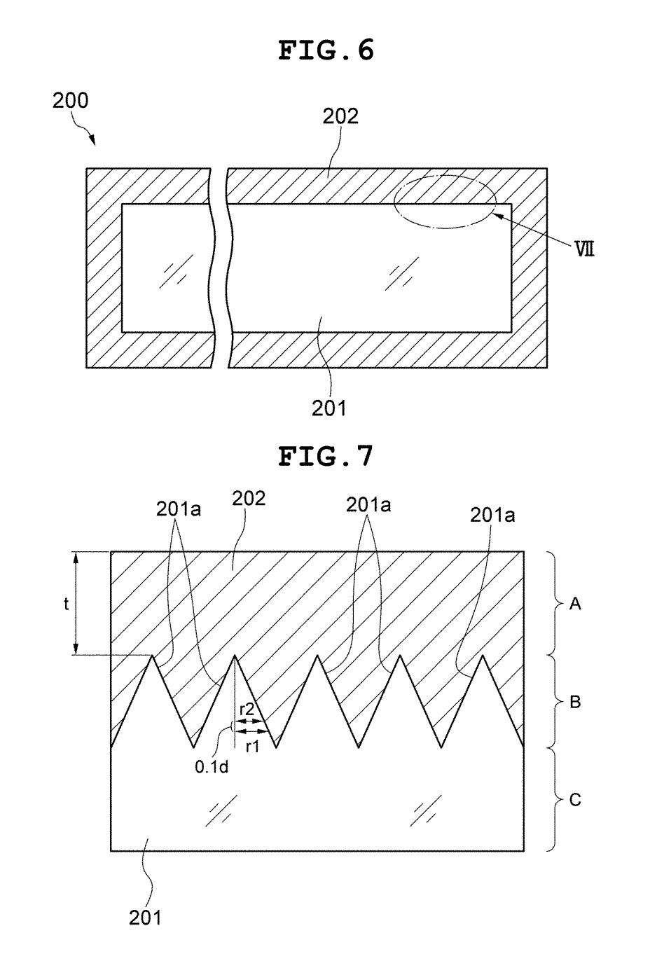

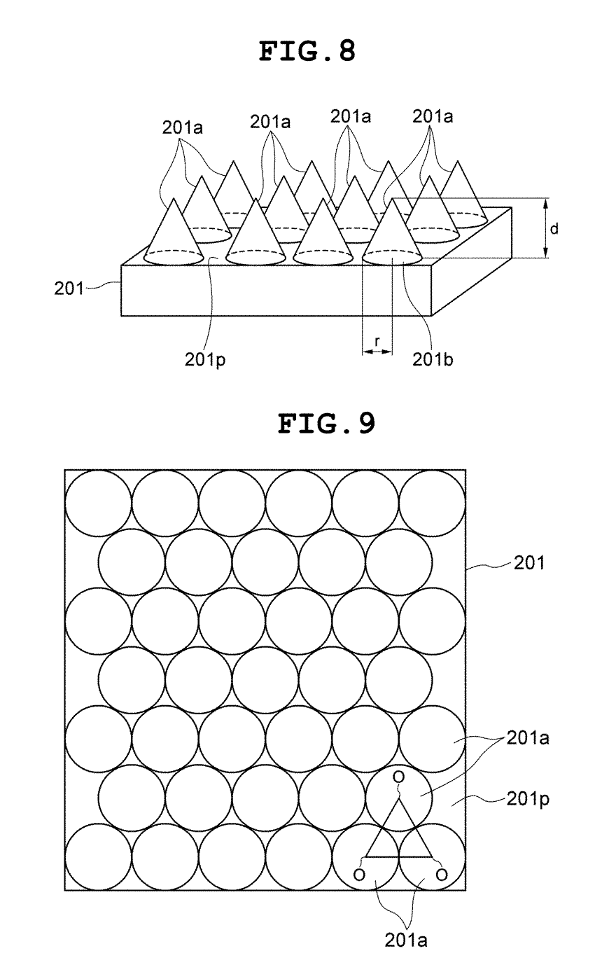

FIG. 6 is an illustration schematically showing a cross section of the combiner 200 according to one or more embodiments. FIG. 7 is a schematic diagram showing a portion indicated with an arrow VII in FIG. 6 by enlarging the portion. FIG. 8 is a perspective view showing the surface of a base by enlarging the surface. The combiner 200 is constituted such that a plurality of conical protrusions 201a as shown in FIGS. 7 and 8 are formed integrally at least on a surface 201p on the projection plane side of the plate-shaped base 201 made of resin with a refractive index nc and a hard coat layer 202 is formed so as to cover the conical protrusions 201a. The hard coat layer 202 with a refractive index ns different from the refractive index nc is filled up between the adjoining conical protrusions 201a without gaps.

Each of the conical protrusions 201a has a common shape, and, in FIG. 8, each of the height d of the conical protrusion 201a from the surface 201p of the base 201 and the radius r in a cross section (the bottom surface 201b indicated with a dotted line in FIG. 8) obtained by cutting the conical protrusion 201a along the surface 201p of the base 201 at a position nearest to the base 201 is made a dimension of 700 nm or less. Moreover, with reference to FIG. 7, with respect to the radius r1 of a cross section obtained by cutting the conical protrusion 201a in parallel to the bottom surface 201b at a position of an arbitrary height of the conical protrusion 201a, the radius r2 of a cross section obtained by cutting the conical protrusion 201a in parallel to the bottom surface 201b at a position moved up by 0.1d from the position of the arbitrary height is made within a range of 0.7r1 to 0.9r1.

Furthermore, with respect to a unit area (for example, the area of the surface 201p of the base 201 shown in FIG. 8) of the base 201, the total area of the bottom surfaces 201b of the conical protrusions 201a is 70% or more and 92% or less. Moreover, in FIG. 7, the combiner 200 includes, from the atmospheric air side, a region A in which only the hard coat layer 202 exists, a region B in which the hard coat layer 202 and the conical shape projections 201a mixedly exist, and a region C in which only the base 201 exists. The thickness of the region A, i.e., the thickness t in the hard coat layer 201 from the tip of the conical protrusion 201a to a surface opposite to the base 201 is 1 to 10 μm. In the region B, it can be considered that the refractive index changes smoothly as a whole.

Although not shown in the drawings, on the surface of the hard coat layer 202, it is possible to form a half mirror film and the like used for image projection by vapor deposition and the like.

FIG. 9 is an illustration in which the surface of the base 201 according to one or more embodiments is looked down from the upper portion of the conical protrusion. In one or more embodiments, the bottom surfaces of the adjoining conical protrusions 201a are made to come in contact with each other, namely, the conical protrusions 201a are disposed in a manner of so-called closest packing. At this time, the total area of the bottom surfaces 201b of the conical protrusions 201a is 92% with respect to the unit area of the base 201. In the case where the centers O of the bottom surfaces 201b of three conical protrusions 201a adjoining each other are connected with straight lines, the straight lines form an equilateral triangle as shown in FIG. 9. In the example shown in FIG. 8, it is permissible to do the same manner.

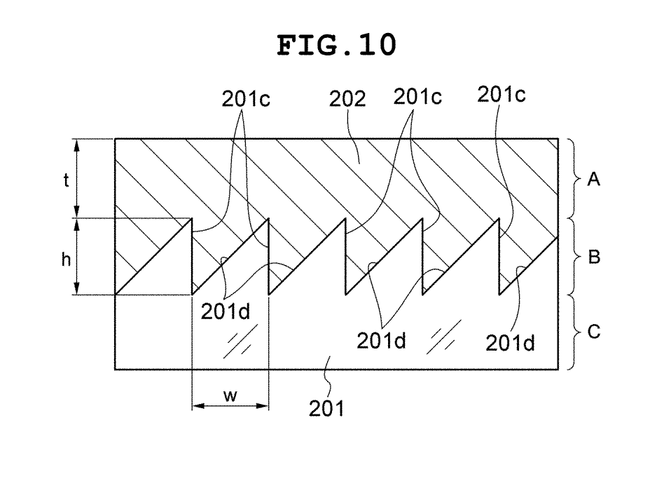

FIG. 10 is a cross sectional view, similar to FIG. 7, of a combiner according one or more embodiments. In one or more embodiments, on the surface of the base 201, a plurality of grooves each having a triangular cross section including a vertical surface 201c existing so as to extend in a direction separating from the base 201 and a slope surface inclining with respect to the vertical surface 201c, are formed along in a direction vertical to the surface of the sheet so as to extend in parallel to each other, and a hard coat layer 202 covers on the plurality of grooves. The plurality of grooves constitute a periodic configuration. Each of the height h of the vertical surface 201c from the base 201 and the width w of the slope surface 202d is made a dimension of 700 nm or less. The other constitutions including the thickness t of the hard coat layer 202 are the same as those of one or more embodiments described above.

Next, the main manufacturing processes of the combiner 200 are described.

(1) Processing of a Mold

First, a mold for transferring and forming a base is processed. A transfer surface for transferring and forming an optical surface of a base and conical protrusions is formed in the mold. Here, minute shape processing is needed for the transfer surface of conical protrusions. As this minute shape processing, there are many approaches, such as minute processing by an electron beam, direct processing utilizing porous arrays by the anodic oxidation method of a bulb metal, indirect processing using nanoimprint techniques, and the like, and it is possible to select these techniques suitably. The effects of one or more embodiments of the present invention do not depend on the processing method.

(2) Molding Processing

Here, the base is subjected to resin molding by using general injection molding. In order to transfer the minute structure of conical protrusions with accuracy sufficient enough, the mold is held at a high temperature so as to increase fluidity, and simultaneously, degassing at the time of molding resin is performed. Moreover, in consideration of shrinkage of a molded product, the depth of the transfer surface of conical protrusions is increased.

(3) Pressurized Impregnation Coating (Hard Coat Coating)

Coating is performed by two stages in order to penetrate a hard coat liquid sufficiently between concave and convex of conical protrusions of the molded base. The pressurized coating and the reduced-pressure degassing are performed by using a hard coat liquid with a high degree of dilution in order to make viscosity low. Thereafter, the normal coating is performed again. In the laminate coating at the second stage, a dip method, a spin coating method, or the like is used. Then, the hard coat liquid is dried and hardened, thereby obtaining a hard coat layer.

### EXAMPLE

Hereinafter, examples are described.

First, a STAVAX material was applied with electroless nickel plating and was subjected to transfer surface configuration processing for an optical surface. Thereafter, on the material, a Cr thin film with a thickness 30 nm, and a metallic aluminum thin film with a thickness of 1000 nm were formed by magnetron sputtering methods. Then, on the film, conical pores (holes) were formed and arranged in equilateral triangle lattice by multi stage anodic oxidation methods using a mixed solution of oxalic acid and sulfuric acid in which their concentrations were adjusted to sulfuric acid 150 g/L:oxalic acid 10 g/L, whereby a mold for injection moldings was obtained. The process for obtaining conical pores are adjusted based on the kind of resins, molding conditions, and the transferability of configuration. In this example, the conditions were made such that the conical configuration after molding became d=300 nm and r=200 nm. The pore wide process was inserted for every effective pore depth of 100 nm, and the pore wide process was repeated 3 times.

Furthermore, by using the obtained mold, a polycarbonate resin manufactured by Mitsubishi Engineering Plastics Company “Iupilon S-3000” (trade name) was injection molded as mentioned above, and a test piece (plate (300 mm×300 mm)) imitated a base was molded. With this injection molding, a plurality of test pieces on which the respective conical protrusions different in height d, radius r of a bottom surface, and density were formed, were prepared. The configuration and arrangement of conical protrusions transferred at the time of molding were observed with the field emission electron microscope S-800 (trade name) manufactured by Hitachi High-technologies Corporation.

Subsequently, the hard coat coating was performed to the test pieces. In concrete terms, hard coat coating liquid was made to penetrate sufficiently concavo-convex portions on the surface of each of the test pieces by using the in-house coating apparatus, further immersion coating was performed for them so as to secure a predetermined thickness, and thereafter the test pieces were dried by a dry oven so as to perform post-cure. Successively, UV cure was performed for the test pieces by using a UV irradiation machine “GRANDEAGE ECS-401X” (trade name) manufactured by TAKEN Incorporation. With the above processes, the test pieces (Examples and Comparative examples) different in the material and thickness t of the hard coat layer from each other were obtained.

Hereinafter, the specification of each of the test pieces of Examples and the test pieces of Comparative examples is described.

### Example 1

the radius r of the bottom surface of conical protrusions=250 nm, the height d=250 nm, the density=80%, the material of the hard coat layer=UV curing acrylic, the thickness t=2.5 μm

### Example 2

the radius r of the bottom surface of conical protrusions=400 nm, the height d=300 nm, the density=88%, the material of the hard coat layer=UV curing acrylic, the thickness t=5.0 μm

### Example 3

the radius r of the bottom surface of conical protrusions=100 nm, the height d=150 nm, the density=75%, the material of the hard coat layer=UV curing acrylic, the thickness t=2.0 μm

### Example 4

the radius r of the bottom surface of conical protrusions=440 nm, the height d=250 nm, the density=80%, the material of the hard coat layer=UV curing acrylic, the thickness t=2.5 μm

### Example 5

the radius r of the bottom surface of conical protrusions=90 nm, the height d=250 nm, the density=80%, the material of the hard coat layer=UV curing acrylic, the thickness t=2.5 μm

### Example 6

the radius r of the bottom surface of conical protrusions=250 nm, the height d=350 nm, the density=80%, the material of the hard coat layer=UV curing acrylic, the thickness t=2.5 μm

### Example 7

the radius r of the bottom surface of conical protrusions=250 nm, the height d=140 nm, the density=80%, the material of the hard coat layer=UV curing acrylic, the thickness t=2.5 μm

### Example 8

the radius r of the bottom surface of conical protrusions=250 nm, the height d=250 nm, the density=70%, the material of the hard coat layer=UV curing acrylic, the thickness t=2.5 μm

### Example 9

the radius r of the bottom surface of conical protrusions=250 nm, the height d=250 nm, the density=80%, the material of the hard coat layer=silicone, the thickness t=2.5 μm

### Example 10

the radius r of the bottom surface of conical protrusions=250 nm, the height d=250 nm, the density=80%, the material of the hard coat layer=UV curing acrylic, the thickness t=6.0 μm

### Example 11

the radius r of the bottom surface of conical protrusions=250 nm, the height d=250 nm, the density=80%, the material of the hard coat layer=UV curing acrylic, the thickness t=1.8 μm

### Example 12

the radius r of the bottom surface of conical protrusions=440 nm, the height d=140 nm, the density=70%, the material of the hard coat layer=heat curing acrylic, the thickness t=1.8 μm

### Comparative Example 1

the radius r of the bottom surface of conical protrusions=800 nm, the height d=140 nm, the density=70%, the material of the hard coat layer=heat curing acrylic, the thickness t=1.8 μm

### Comparative Example 2

the radius r of the bottom surface of conical protrusions=440 nm, the height d=800 nm, the density=70%, the material of the hard coat layer=heat curing acrylic, the thickness t=1.8 μm

### Comparative Example 3

the radius r of the bottom surface of conical protrusions=440 nm, the height d=140 nm, the density=50%, the material of the hard coat layer=heat curing acrylic, the thickness t=1.8 μm

### Comparative Example 4

the radius r of the bottom surface of conical protrusions=440 nm, the height d=140 nm, the density=70%, the material of the hard coat layer=heat curing acrylic, the thickness t=11.0 μm

### Comparative Example 5

the radius r of the bottom surface of conical protrusions=440 nm, the height d=140 nm, the density=70%, the material of the hard coat layer=heat curing acrylic, the thickness t=0.5 μm

### Comparative Example 6

the test piece was formed by the production method described in Japanese Unexamined Patent Publication No. H08-94801, and the refractive index was made to incline by performing CVD film formation of organic silane compound onto the base.

### Comparative Example 7

the test piece was formed by the production method described in Japanese Unexamined Patent Publication No. 2003-205563, and the base and the hard coat layer were bonded with a melting surface so that the interface was made a mixed layer.

### Comparative Example 8

the test piece was formed by the production method described in Japanese Unexamined Patent Publication No. 2000-111706, and the refractive index of the interface was made to change stepwise so as to reduce interlayer reflection.

### Comparative Example 9

the test piece was formed by the production method described in Japanese Unexamined Patent Publication No. H08-197670, and the base was roughened with blasting, embossing, beads or the like.

(Evaluation Item and its Method)

At the outset, in the present specification, in the following evaluation criteria, a rank “A” represents “excellent”, a rank “B” represents “good”, a rank “C” represents “average”, and a rank “D” represents “bad”.

a) Pencil Hardness

Based on JIS K5600-5-4 standard, the surface hardness was measured using the in-house pencil hardness tester. Although the main evaluation was based on a surface hardness, not only surface crack but also internal destruction of a cone portion was put into criteria. Evaluation criteria was determined as follows. B: 2H or more, C: H or F, D: HB or less

b) Appearance after Coating

“Smooth coatability (leveling upheaval)” and “interference color unevenness” were visually functionally evaluated, and then, were ranked. In concrete terms, on the supposition of the use state of a head mounted display apparatus, reflection light was visually observed from an observation distance of 50 cm. Evaluation criteria was determined as follows. B: leveling upheaval and interference color unevenness cannot be visually discriminated, C: any one of leveling upheaval and interference color unevenness can be visually discriminated, D: both leveling upheaval and interference color unevenness can be visually discriminated

c) Flatness of Spectral Reflectance

Absolute value evaluation was performed through total reflectivity measurement by the spectrophotometer “U4100” (trade name) manufactured by Hitachi High-technologies Corporation. In concrete terms, in the wavelength band region of 400 nm to 700 nm, a difference A % R between the maximum value and the minimum value of reflectance was obtained. Evaluation criteria was determined as follows. B: Δ % R is less than 0.5%, C: Δ % R is 0.5% or more and less than 1.0%, D: Δ % R is 1.0% or more

d) Haze

Haze values were obtained by performing measurement based on JIS K 7136 standard by using the haze meter “NDH7000” (trade name) manufactured by Nippon Denshoku Industries. Evaluation criteria was determined as follows. B: less than 0.5%, C: 0.5% or more and less than 1.0%, D: 1% or more

e) Heat Resistance Reliability

On the supposition of environment at the time of being mounted on a car, the test pieces were kept in a dry oven at 105° C. for 1000 hours. Thereafter, a degree of each of cracks and peeling off of hard coat was determined by the outer appearance observation, and the number of in-plane defect occurrence portions by the outer appearance observation with a stereoscopic microscope was recorded. Evaluation criteria was determined as follows. A: there is no surface crack, no internal crack, and no peeled coat, B: there is no internal crack, and surface cracks and peeled coat each starting from the outer edge occur, but do not occur on non-outer edge portions, C: 1 to 4 internal cracks, and cracks and peeled coats on non-outer edge portions occur, D: 5 or more internal cracks, and cracks and peeled coats on non-outer edge portions occur

f) Humidity Resistance Reliability

On the supposition of environment at the time of being mounted on a car, the test pieces were kept in a dry oven at 70° C. and 95% Rh for 1000 hours. Thereafter, a degree of each of cracks and peeling off of hard coat was determined by the outer appearance observation, and the number of in-plane defect occurrence portions by the outer appearance observation with a stereoscopic microscope was recorded. Evaluation criteria was determined as follows. A: there is no surface crack, no internal crack, and no peeled coat, B: there is no internal crack, and surface cracks and peeled coat each starting from the outer edge occur, but do not occur on non-outer edge portions, C: 1 to 4 internal cracks, and cracks and peeled coats on non-outer edge portions occur, D: 5 or more internal cracks, and cracks and peeled coats on non-outer edge portions occur

The evaluation results are collectively shown in Table 1.

TABLE 1

| | | | Flatness of | | Heat resistance | Humidity resistance |
|---|---|---|---|---|---|---|
| | Pencil | Appearance | spectral | | reliability | reliability |
| | hardness | after coatng | reflectance | Haze | (appearance | (appearance |
| | (JIS | (visual | (U4100 | (JIS K | observation | observation |
| | K5600-5-4) | observation) | spectrophotometer) | 7136) | determination) | determination) |
| Example 1 | ◯ | ◯ | ◯ | ◯ | ⊚ | ⊚ |
| Example 2 | ◯ | ◯ | ◯ | ◯ | Δ | ⊚ |
| Example 3 | ◯ | ◯ | ◯ | ◯ | ⊚ | ⊚ |
| Example 4 | ◯ | ◯ | Δ | Δ | ⊚ | ⊚ |
| Example 5 | Δ | ◯ | ◯ | ◯ | Δ | Δ |
| Example 6 | Δ | ◯ | Δ | Δ | ◯ | ◯ |
| Example 7 | ◯ | ◯ | Δ | ◯ | ⊚ | ⊚ |
| Example 8 | ◯ | ◯ | ◯ | ◯ | ⊚ | ⊚ |
| Example 9 | ◯ | Δ | ◯ | ◯ | ⊚ | ⊚ |
| Example 10 | ◯ | ◯ | ◯ | ◯ | Δ | ⊚ |
| Example 11 | Δ | ◯ | ◯ | ◯ | ⊚ | ⊚ |
| Example 12 | Δ | Δ | ◯ | Δ | ⊚ | ⊚ |
| Comparative Example 1 | Δ | X | X | X | ⊚ | ⊚ |
| Comparative Example 2 | Δ | X | X | Δ | X | X |
| Comparative Example 3 | ◯ | X | X | X | ⊚ | ⊚ |
| Comparative Example 4 | ◯ | Δ | Δ | Δ | X | Δ |
| Comparative Example 5 | X | Δ | Δ | Δ | ⊚ | ⊚ |
| Comparative Example 6 | X | ◯ | ◯ | ◯ | X | X |
| Comparative Example 7 | ◯ | ◯ | X | X | ◯ | ◯ |
| Comparative Example 8 | ◯ | Δ | Δ | ◯ | X | X |
| Comparative Example 9 | ◯ | ◯ | Δ | X | ◯ | ◯ |

(Consideration)

Comparative example 1 did not satisfy the criteria in the evaluation of b) appearance after coating, c) flatness of spectral reflectance, and d) haze. This is interpreted such that internal fracture, scattering of light and the like are liable to occur due to the cause that the radius r of the bottom surface of the conical projection is too large. Comparative example 2 did not satisfy the criteria in the evaluation of b) appearance after coating, c) flatness of spectral reflectance, e) heat resistance reliability, and f) humidity resistance reliability. This is interpreted such that internal fracture, scattering of light and the like are liable to occur due to the cause that the radius r of the bottom surface is too large. Comparative example 3 did not satisfy the criteria in the evaluation of b) appearance after coating, c) flatness of spectral reflectance, and d) haze. This is interpreted due to the cause that the density of conical protrusions is too low. Comparative example 4 did not satisfy the criteria in the evaluation of e) heat resistance reliability. This is interpreted due to the cause that cracks and peeling occur because the thickness t of the hard coat layer is too thick. Comparative example 5 did not satisfy the criteria in the evaluation of a) pencil hardness. This is interpreted due to the cause that the thickness t of the hard coat layer is too thin. Comparative example 6 did not satisfy the criteria in the evaluation of a) pencil hardness, e) heat resistance reliability, and f) humidity resistance reliability. Comparative example 7 did not satisfy the criteria in the evaluation of c) flatness of spectral reflectance, and d) haze. Comparative example 8 did not satisfy the criteria in the evaluation of e) heat resistance reliability, and f) humidity resistance reliability. Comparative example 9 did not satisfy the criteria in the evaluation of d) haze. In contrast, with regard to Examples 1 to 12, approximately good evaluation was obtained in each of the evaluation items a) to f). With this, the effects of one or more embodiments of the present invention were confirmed.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, in one or more embodiments, the display member and head-up display apparatus can be used not only for cars but also for airplanes and heavy industrial machines, and they may be used by being installed in the vicinity of a sun visor placed above a driver, and may be used for a wearable terminal. Furthermore, the functional film may be formed on the both sides of the base plate.

### REFERENCE SIGNS LIST

100 Image Drawing Unit
111 Liquid Crystal Display Panel
120 Concave Mirror
130 Housing
200 Combiner
201 Base
201a Conical Protrusion
201b Bottom Surface
201c Vertical Surface
201d Slope Surface
DB Dashboard
DR Driver
GT Gate
VH Car Body

1. A display member having a projection plane for use in a head-up display apparatus, wherein when display light is emitted to the projection plane, the display light is reflected on the projection plane, which enables an image shown by the display light to be observed as a virtual image, and enables a real image having passed through the display member to be observed, the display member comprising:
a base made of resin; and
a hard coat layer disposed on the base,
wherein a plurality of conical protrusions protrude from a surface of the base and are covered with the hard coat layer,
wherein each of a height d of the conical protrusion from the surface of the base and a radius r of a cross section of a bottom surface obtained by cutting the conical protrusion along the surface of the base at a position nearest to the base is a dimension of 700 nm or less, and
wherein a total area of the bottom surface of the conical protrusions is 70% to 92% with respect to a unit area of the base.

2. The display member according to claim 1, wherein with respect to a radius r1 of a cross section obtained by cutting the conical protrusion in parallel to the bottom surface at a position of an arbitrary height of the conical protrusion, the a radius r2 of a cross section obtained by cutting the conical protrusion in parallel to the bottom surface at a position moved up by 0.1d from the position of the arbitrary height is 0.7r1 to 0.9r1.

3. The display member according to claim 1, wherein in a case where centers of the bottom surfaces of three conical protrusions adjoining each other are connected with straight lines that form an equilateral triangle.

4. A display member having a projection plane for use in a head-up display apparatus, wherein when display light is emitted to the projection plane, the display light is reflected on the projection plane, which enables an image shown by the display light to be observed as a virtual image, and enables a real image having passed through the display member to be observed, the display member comprising:
a base made of resin; and
a hard coat layer disposed on the base,
wherein a periodic configuration is disposed on a surface of the base and covered with the hard coat layer,
wherein the periodic configuration is a configuration in which a plurality of grooves are disposed along the surface of the base and extends in parallel to each other,
wherein each of the plurality of grooves includes a vertical surface that extends from the base and a slope surface that is inclined to the vertical surface, and
wherein each of a height of the vertical surface from the base and a width w of the slope surface becomes 700 nm or less.

5. The display member according to claim 1, wherein the hard coat layer is formed by a wet coating method.

6. The display member described according to claim 1, wherein the base is made of at least one resin selected from a group consisting of: a polycarbonate type, a PMMA type, a COC type, and a COP type.

7. The display member according to claim 1, wherein the hard coat layer is formed from transparent resin curable materials of an acrylic type or a silicone type.

8. The display member according to claim 1, wherein a thickness t of the hard coat layer is 1 μm to 10 μm.

9. A head-up display apparatus, comprising:
the display member according to claim 1, and an image drawing unit that emits display light to the display member.

10. The head-up display apparatus according to claim 9, wherein the head-up display apparatus is mounted on a car and disposed on a position that can be observed by a driver.

11. The head-up display apparatus according to claim 10, wherein the head-up display apparatus is disposed on a dashboard of the car.
